(19) United States
(12) Patent Application Publication
(10) Pub. No.: US 2026/0193548 A1
(43) Pub. Date: Jul. 9, 2026

(54) SYSTEMS AND METHODS OF OIL SWEETENING AND HYDROGEN PRODUCTION

(71) Applicant: Saudi Arabian Oil Company, Dhahran (SA)

(72) Inventors: Simon A. Stewart, Dhahran (SA); Serguey Viktorov Arkadakskiy, Dhahran (SA)

(21) Appl. No.: 19/011,769

(22) Filed: Jan. 7, 2025

(51) Int. Cl. C10G 29/04; C01B 3/08; E21B 43/295

(52) U.S. Cl. CPC C10G 29/04; C01B 3/08; E21B 43/295; C01B 2203/063; C10G 2300/1033; C10G 2300/207

(57) ABSTRACT

Provided herein are methods and systems of simultaneous oil sweetening and hydrogen production. The method includes introducing a sour oil stream containing hydrogen sulfide (H₂S) from a source reservoir into a scavenging reservoir containing one or more types of reactive iron-bearing minerals, and contacting the sour oil stream with the one or more types of reactive iron-bearing minerals present in the scavenging reservoir, thereby generating a sweet oil stream having a low-reduced H₂S content as compared to the sour oil stream and an iron sulfide scale deposited within the scavenging reservoir and forming a hydrogen gas cap in an upper portion of the scavenging reservoir beneath a cap rock seal.

### TECHNICAL FIELD

The present disclosure relates to methods and systems of simultaneous oil sweetening and hydrogen production, more particularly, to methods and systems for treating a hydrogen sulfide (H₂S)-containing sour oil stream in subsurface geological formations and simultaneously generating hydrogen gas (H₂).

### BACKGROUND

Hydrogen sulfide (H₂S) is a common component in hydrocarbon fields, often mixed with oil or gas. The presence of H₂S often poses challenges to the oil and gas industries due to its toxicity, corrosion, and removal costs. Sour hydrocarbons with high concentrations of H₂S must be treated to reduce the H₂S content, generating sweetened hydrocarbons before entering the market. However, this process incurs significant operating costs for separation equipment and poses risks associated with H₂S exposure to workers and nearby infrastructure, leading to many sour hydrocarbon fields remaining undeveloped.

Additionally, pure hydrogen is in high demand but is usually produced through energy-intensive processes. Consequently, there is a need for cost-effective and sustainable methods and systems to produce hydrogen gas alongside sweetened hydrocarbons, addressing both H₂S management and hydrogen production challenges.

### SUMMARY

In an exemplary embodiment, a method of simultaneous oil sweetening and hydrogen production is provided. The method includes introducing a sour oil stream containing hydrogen sulfide (H₂S) from a source reservoir into a scavenging reservoir containing one or more types of reactive iron-bearing minerals and/or rock fragments; contacting the sour oil stream with the one or more types of reactive iron-bearing minerals and/or rock fragments present in the scavenging reservoir, thereby generating a sweet oil stream having a reduced H₂S content as compared to the sour oil stream and an iron sulfide scale deposited within the scavenging reservoir and forming a hydrogen gas cap in an upper portion of the scavenging reservoir beneath a cap rock seal; and flowing the sweet oil stream into a sweet oil storage unit via a sweet oil production well and flowing the hydrogen gas cap into a hydrogen storage unit via a hydrogen production well.

In some embodiments, the one or more types of reactive iron-bearing minerals are selected from the group consisting of ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, hornblende, garnet (almandine), vivianite, jarosite, glauconite, iron chlorite, and native iron.

In some embodiments, the one or more types of reactive iron-bearing minerals contain ferrous iron and ferric iron.

In some embodiments, the iron sulfide scale contains at least one of pyrite, pyrrhotite, troilite, greigite, mackinawite, or marcasite.

In some embodiments, the iron sulfide scale contains pyrite.

In some embodiments, the H₂S is present in the sour oil stream in an amount of more than about 1000 parts per million (ppm) based on a total weight of the sour oil stream.

In some embodiments, the H₂S is present in the sweet oil stream in an amount of less than about 4 ppm based on a total weight of the sweet oil stream.

In some embodiments, the source reservoir and the scavenging reservoir are distantly located from each other and cannot be connected via a reservoir connector well.

In some embodiments, the source reservoir and the scavenging reservoir are closely located to each other and are in direct fluid communication with each other via a reservoir connector well.

In some embodiments, the source reservoir is located beneath the scavenging reservoir and is separated by a low-permeability geological formation.

In some embodiments, the source reservoir has a higher pore fluid pressure than the scavenging reservoir, thereby allowing the sour oil stream to flow from the source reservoir into the scavenging reservoir in the absence of a pump to lift the sour oil stream.

In some embodiments, the source reservoir is in fluid communication with the scavenging reservoir via the reservoir connector well.

In some embodiments, the source reservoir is in fluid communication with a water source via a water injection well.

In some embodiments, the scavenging reservoir is in fluid communication with the water source via a water injection well.

In an exemplary embodiment, the method of simultaneous oil sweetening and hydrogen production further includes monitoring a concentration of the iron sulfide scale in the scavenging reservoir; and in response to the concentration of the iron sulfide scale exceeding a threshold concentration, stopping the introduction of the sour oil stream from the source reservoir into the scavenging reservoir.

In some embodiments, the presence and/or concentration of the iron sulfide scale present in the scavenging reservoir is obtained by a surface-based remote sensing technique selected from the group consisting of a four-dimensional (4D) reflection seismic survey technique, a gravity survey technique, a magnetic survey technique, and a magnetotellurics survey technique.

In an exemplary embodiment, a system for simultaneous oil sweetening and hydrogen production is provided. The system includes a source reservoir comprising a sour oil stream comprising hydrogen sulfide (H₂S); a reservoir connector well configured to flow the sour oil stream from the source reservoir into a scavenging reservoir; the scavenging reservoir containing one or more types of reactive iron-bearing minerals capable of reacting with the H₂S in the sour oil stream with the one or more types of reactive iron-bearing minerals to generate a sweet oil stream having a reduced H₂S content as compared to the sour oil stream, an iron sulfide scale deposited within the scavenging reservoir, and a hydrogen gas cap in an upper portion of the scavenging reservoir beneath a cap rock seal; a sweet oil production well configured to flow the sweet oil stream; a hydrogen production well configured to flow the hydrogen gas cap; a water injection well configured to flow water into the source reservoir, thereby allowing the sour oil stream to flow from the source reservoir to the scavenging reservoir and supporting fluid movement within the scavenging reservoir and the source reservoir; and a surface-based remote sensing sensor.

In some embodiments, the source reservoir is located beneath the scavenging reservoir and is in fluid communication with the scavenging reservoir via the reservoir connector well.

In some embodiments, the surface-based remote sensing sensor is configured to measure and monitor a concentration of the iron sulfide scale in the scavenging reservoir.

In an exemplary embodiment, the system for simultaneous oil sweetening and hydrogen production further includes a sweet oil storage unit in fluid communication with the scavenging reservoir via the sweet oil production well; a hydrogen storage unit in fluid communication with the scavenging reservoir via the hydrogen production well; a sour oil storage unit in fluid communication with the source reservoir via the reservoir connector well; and a water source in fluid communication with the source reservoir via the water injection well.

### BRIEF DESCRIPTION OF THE DRAWINGS

FIG. 1 is a schematic diagram depicting an initial subsurface geological formation containing a source reservoir and a scavenging reservoir, according to certain embodiments of the present disclosure.

FIG. 2 is a schematic diagram depicting a system (100) for simultaneous oil sweetening (“desulphurization”) and hydrogen production in the subsurface geological formation, according to certain embodiments of the present disclosure.

FIG. 3 is a schematic diagram depicting the system (100) after simultaneous oil sweetening and hydrogen production, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “substantially” refers to a majority of, or mostly, as in at least about 50%, such as about 60%, about 70%, about 80%, about 90%, about 95%, about 96%, about 97%, about 98%, about 99%, about 99.5%, about 99.9%, about 99.99%, or at least about 99.999% or more.

As used herein, the terms “wellbore” or “well” refer to a hole drilled into the earth extending from the surface down to a subterranean formation capable of accessing a reservoir of oil, gas, water, or other subsurface resources. The wellbore of the present disclosure includes, but is not limited to, a bored well, a production well, a reservoir-crossflow well, an injection well, a water source well, a relief well, and an exploration well. Additionally, the wellbore can be vertical, horizontal, or positioned at any angle within the formation. A wellbore forms a pathway capable of permitting both fluids and apparatus to traverse between the surface and the formation or to crossflow between geological formations without lifting fluids to the ground. Besides defining the void volume of the wellbore, the wellbore wall also acts as the interface through which fluid can transition between the subterranean formation and the interior of the wellbore. The wellbore wall can be unlined (that is, bare rock or formation) to permit such interaction with the formation, or lined, such as by a tubular string, casing, tubing, or liners, so as to prevent or restrict such interactions. In cases where the wellbore is lined, perforations can be made at specific depths of the wellbore to allow controlled access to subsurface resources of interest. Additionally, the wellbore may include completion equipment installed inside the tubing, such as valves and other control systems, to manage and regulate fluid movement between the reservoir and the wellbore. As used throughout this disclosure, the term “fluid” can include liquids, gases, or both.

As used herein, the terms “formation crossflow well,” and “crossflow well” refer to a channel that fluidly connects the two adjacent rock formations, e.g., a source reservoir and a scavenging reservoir. A crossflow well can be in fluid communication with reactive iron-bearing minerals in the scavenging reservoir and be configured to allow fluids, such as a hydrocarbon solution of one or more dissolved non-hydrocarbon gases, to be delivered to react with the one or more types of reactive iron-bearing minerals in each rock formation.

As used herein, the term “geological formation” refers to a body of rock that is sufficiently distinctive and continuous that it can be mapped, and can include a rock formation, a rock reservoir, a reactive rock formation, a reactive rock reservoir, a water-containing formation, or deep aquifer, among others. As used herein, the term “rock” refers to naturally occurring solid minerals, collections of minerals, or petrochemical substances. The collection of rocks is referred to as a “rock formation.” Types of rocks include, but is not limited to, igneous rock, metamorphic rock, limestone, sedimentary rock, crystalline rock, and combinations thereof. As an example, a scavenging reservoir may contain sedimentary rocks, such as shale, sandstone, limestone, ironstone, banded iron formations (BIFs), conglomerate, claystone, and siltstone. These sedimentary rocks can contain significant amounts of iron-bearing minerals that are reactive with H₂S, including but not limited to, hematite, magnetite, siderite, pyrite, goethite, and limonite, either as primary components or as impurities. In some examples, the scavenging reservoir contains sandstone within a sedimentary basin. A geological formation containing sedimentary rocks can allow components of an injected stream to react in situ with the sedimentary rocks to precipitate and store components of the injected stream in the formation. As used herein, a H₂S reactive rock may include igneous mafic rocks, igneous ultramafic rocks and minerals and/or fragments thereof, or any rock with iron-bearing minerals such as sedimentary or metamorphic rock. The term mafic generally describes a silicate mineral or igneous rock or metamorphic rocks that are rich in 1o magnesium and iron. Mafic minerals can be dark in color, and examples of rock-forming mafic minerals include rhyolite, granite, olivine, pyroxene, amphibole, and biotite. Examples of mafic metamorphic rocks include melanocratic schist, gneiss, and eclogite. Chemically, mafic and ultramafic igneous and metamorphic rocks can be enriched in iron, magnesium, and calcium.

As used herein, the terms “downhole” or “uphole” refer to a position within a wellbore relative to the surface, with uphole indicating direction or position closer to the surface and downhole referring to direction or position farther away from the surface.

As used herein, the term “subsurface formation” refers to a body of rock that is sufficiently distinctive and continuous from the surrounding rock bodies that the body of the rock may be mapped as a distinct entity. A subsurface formation is, therefore, sufficiently homogenous to form a single identifiable unit containing similar properties throughout the subsurface formation, including, but not limited to, porosity and permeability.

As used herein, “impermeable” means a permeability of zero or of very low permeability, such as in the range of NanoDarcys. “Darcy” as used herein, refers to the unit for permeability of a medium under Darcy's Law.

As used herein, the term “brine” (e.g., natural brine) refers to a solution that contains predominantly one or more monovalent or divalent metal chlorides. For example, “brine” can refer to a solution of NaCl, KCl, CaCl₂), MgCl₂, or other water soluble salts, or mixtures thereof. Alternatively, the term “brine” can refer to sedimentary basin brine, which originates from salt (evaporite) dissolution or of residual evaporitic brine origin, or naturally derived saltwater, for example, seawater or salt lake water. Brine can be used in its natural state or after having undergone processing, such as filtration, to remove contaminants and large particles. In the present disclosure, the brine is sedimentary basin brine having a total dissolved solids (TDS) of about 35,000 parts per million (ppm) to about 400,000 ppm.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the foregoing, one objective of the present disclosure is to provide a method of simultaneous oil sweetening and hydrogen production. A second objective of the present disclosure is to provide a system for simultaneous oil sweetening and hydrogen production. The method and system of the present disclosure leverage naturally occurring, in-situ geological formations to facilitate subsurface sweetening and hydrogen production without requiring any external energy input. This approach contrasts with surface-based oil sweetening processes like the Claus process, which is usually energy-intensive. The Claus process, commonly used to convert hydrogen sulfide extracted from natural gas, crude oil, or other industrial sources into sulfur, operates above ground and demands significant energy.

Provided in this disclosure are methods and systems for simultaneous oil sweetening and hydrogen production using in-situ ferrous iron and/or ferric iron-rich geological minerals that may be distributed in sedimentary, igneous or metamorphic geological reservoirs. The ferrous iron and/or ferric iron can fix the sulfur from the H₂S present in sour hydrocarbons through in-situ H₂S mineralization while liberating hydrogen gas (H₂) as product. The hydrogen gas will accumulate in the same reservoir in which the H₂S scavenging has occurred and can thus be produced as a natural hydrogen gas stream alongside the sweetened hydrocarbons. The sulfur remains sequestered in the scavenging reservoir as harmless and common sulphide minerals, such as pyrite (FeS₂). The scavenging reservoir is a subsurface porous layer (reservoir) rich in iron-bearing (Fe²⁺ and Fe³⁺) minerals including, but not limited to, iron oxides such as magnetite (Fe₃O₄) and hematite (Fe₂O₃), iron hydroxides such as goethite (FeO(OH)), iron-bearing clay minerals such as glauconite ((K,Na)(Fe,Al,Mg)₂(Si,Al)₄O₁₀(OH)₂), and iron-chlorite such as ((Mg,Fe)₃(Si,Al)₄O₁₀(OH)₂(Mg,Fe)₃(OH)₆). Reservoirs rich in such iron minerals can be located via common geological exploration methods. In one example, an iron-rich reservoir is in the strata positioned uphole and adjacent to a sour reservoir. In one example, an iron-rich reservoir is in the strata positioned downhole and adjacent to a sour reservoir. In another example, an iron-rich reservoir is in the strata positioned at approximately the same depth and adjacent to a sour reservoir. Wells (e.g., crossflow wells) and/or surface pipelines allow flow of the sour hydrocarbon from the source reservoir to the iron-rich scavenging reservoir. In some examples, the iron-rich reservoir may exist in an offset location that is away from the sour reservoir, such that the iron-rich reservoir and sour reservoir are laterally separated. In such cases, surface pipework or transport may be required to allow flow of the sour hydrocarbon from the source reservoir to the iron-rich scavenging reservoir.

In the scavenging reservoir, H₂S is removed from the sour hydrocarbon, liberating H₂ while the sulfur is mineralized, for example, as pyrite. The sweetened oil and hydrogen so produced can then be flowed to surface by conventional production wells and any supporting engineering such as pressure support mechanisms. Hydrogen produced from H₂S by this process of geological filtering is referred to as “amber hydrogen.” The subsurface geological formations of the present disclosure can be accommodated by existing drilling engineering and subsurface exploration, production and monitoring technologies including four-dimensional space (4D) seismic.

In the present disclosure, chemical reactions occur in non-igneous geology where Fe-bearing minerals containing both ferrous iron and ferric iron may react with H₂S-containing hydrocarbons, e.g., sour oil or gas. The Equation 1 below describes the removal of H₂S from the hydrocarbons by mineralization to pyrite and simultaneous production of hydrogen. Additionally, due to its high chemical reactivity, H₂S can also be removed from the H₂S-containing hydrocarbons by reactions with ferric iron-bearing minerals such as for example, hematite (Fe₂O₃), in a similar H₂ producing reaction as shown in Equation 2:

2H₂S+Fe²⁺=FeS₂+2H⁺+H₂ Eq. 1

4H₂S+Fe₂O₃=2FeS₂+3H₂O+H₂ Eq. 2

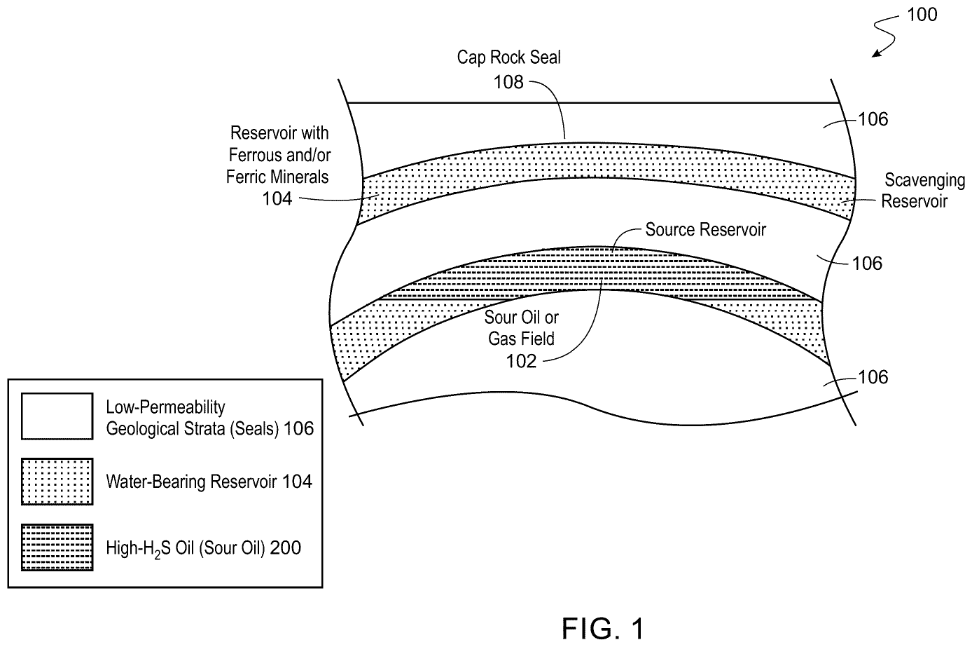

Hydrocarbon fields are generally found in sedimentary basins, where the hydrocarbons mature from source rocks at depth then accumulate in porous reservoir layers such as sandstone or limestone inside the sedimentary basin. In the present disclosure, one or more subsurface sequestration locations containing sedimentary rocks such as sandstone may be identified, where the presence of ferrous iron and/or ferric iron in minerals and/or rock fragments containing those or other iron minerals within a subsurface porous reservoir can be used as a filter and/or a scavenger to remove H₂S from sour hydrocarbon as depicted in FIGS. 1 to 3.

According to an aspect of the present disclosure, a method of simultaneous oil sweetening and hydrogen production includes identifying two or more geological reservoirs including at least one source reservoir containing sour oil and/or sour gas and at least one scavenging reservoir (also referred to as “filtration reservoir”) containing ferrous iron and/or ferric iron in one or more crystalline and/or amorphous phases. In one embodiment, the two or more geological reservoirs are distantly located from each other and are not in direct fluid communication with each other. In another embodiment, the two or more geological reservoirs are closely located to each other and are in direct fluid communication with each other via a reservoir connector well, or a crossflow well. Any method of subsurface mapping that may be standard in, for example, the fields of oil and gas exploration, may be used to identify subsurface geological structures that may include structural highs and the associated sequestration locations. In some embodiments, the mapping is performed by reflection seismic mapping, which uses 2-dimensional reflection seismic data and/or 3-dimensional reflection seismic data, to form a subsurface map of the area under study. Reflection seismic data mapping may be augmented (also referred to as “ground truthed”) by drilled wells (also referred to as “subterranean bores”) to ensure the accuracy of depth on these maps. In some embodiments, maps are constructed from well data alone when a sufficient number of such wells are drilled into the area under study. It may also be possible to use potential field data, such as gravity data, magnetism, or both gravity data and magnetism, to identify subsurface geological structures. In some embodiments, more than one method of identifying the two or more geological reservoirs is used. In some embodiments, each of the two or more geological reservoirs has a temperature of about 10 to about 300° C., such as about 20 to about 250° C., about 40 to about 200° C., about 80 to about 150° C., or about 120° C. In some embodiments, each of the two or more geological reservoirs has a pressure of about 100 to about 60,000 kilopascals (kPa), such as about 1000 to about 50,000 kPa, about 10,000 to about 40,000 kPa, about 20,000 to about 30,000 kPa, or about 25,000 kPa.

The method of simultaneous oil sweetening and hydrogen production also includes introducing a sour oil stream containing hydrogen sulfide (H₂S) from a source reservoir into a scavenging reservoir. In some embodiments, the geometric structure of the source reservoir and the scavenging reservoir are each independently selected from the group consisting of a horizontal structure, an inclined structure, a planar structure, a folded structure, and a faulted structure. In further embodiments, the source reservoir and the scavenging reservoir are each horizontal structures. In further embodiments, the sour oil stream is introduced upwardly from the source reservoir to the scavenging reservoir. The scavenging reservoir is positioned uphole of the source reservoir. In further embodiments, the sour oil stream is introduced downwardly from the source reservoir to the scavenging reservoir. The scavenging reservoir is positioned downhole of the source reservoir. In further embodiments, the scavenging reservoir and the source reservoir are at approximately the same depth.

In some embodiments, the sour oil stream further contains one or more gases selected from the group consisting of carbon dioxide (CO₂) and nitrogen (N₂). In further embodiments, the sour oil stream contains H₂S and CO₂. In further embodiments, the sour oil stream contains H₂S.

In some embodiments, the scavenging reservoir contains one or more types of reactive iron-bearing minerals in the form of crystalline phase and/or amorphous phase and/or rock fragments containing predominantly iron-bearing minerals. In some embodiments, the one or more types of reactive iron-bearing minerals present in the scavenging reservoir are selected from the group consisting of ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, hornblende, garnet (almandine), vivianite, jarosite, glauconite, iron chlorite, and native iron. In further embodiments, the one or more types of reactive iron-bearing minerals are hematite, magnetite, maghemite, goethite, glauconite, or iron chlorite, or combinations thereof. In some embodiments, the one or more types of reactive iron-bearing minerals include glauconite in a clay mineral. The glauconite clay mineral is deposited in marine sandstones that are known as “greensands” due to the color lent to the marine sandstones by the glauconite. In some embodiments, the one or more types of reactive iron-bearing minerals include magnetite and hematite. The magnetite and hematite are deposited in marine sandstones that are known as “redbeds” due to the color lent to the marine sandstones.

In some embodiments, the one or more types of reactive iron-bearing minerals contain ferrous iron and ferric iron. A mass ratio of the ferric iron to the ferrous iron present in the one or more types of reactive iron-bearing minerals is about 1000:1 to about 1:1, such as about 950:1 to about 50:1, about 900:1 to about 100:1, about 850:1 to about 150:1, about 800:1 to about 200:1, about 750:1 to about 250:1, about 700:1 to about 300:1, about 650:1 to about 350:1, about 600:1 to about 400:1, about 550:1 to about 450:1, or about 500:1, about 400:1, about 300:1, about 200:1, or about 100:1. In some embodiments, the H₂S is present in the sour oil stream in an amount of more than about 1000 parts per million (ppm) based on a total weight of the sour oil stream, such as more than about 10,000 ppm, more than about 50,000 ppm, more than about 100,000 ppm, more than about 150,000 ppm, more than about 200,000 ppm, more than about 250,000 ppm, more than about 300,000 ppm, more than about 350,000 ppm, or more than about 400,000 ppm based on the total weight of the sour oil stream. The H₂S present in the sour oil stream is in both dissolved and/or undissolved form. Once introduced into the source reservoir, the H₂S may be retained within the geological basin of the source reservoir for long periods of time. That is, no measurable amount of H₂S may be released from the geological basin for at least 1 year, at least 5 years, at least 10 years, or at least 15 years. The H₂S may be retained with the geological basin for 100 years or more, for instance for 2000 years or more, for 3000 years or more, for 4000 years or more, for 5000 years or more, or even for tens of millions of years or more.

The method of simultaneous oil sweetening and hydrogen production further includes contacting the sour oil stream with the one or more types of reactive iron-bearing minerals present in the scavenging reservoir, thereby generating a sweet oil stream, an iron sulfide scale, and a hydrogen gas cap. The sweet oil stream generated after the contacting of the sour oil stream with the one or more types of reactive iron-bearing minerals has a reduced H₂S content as compared to the sour oil stream. Additionally, the iron sulfide scale is deposited within the scavenging reservoir, and the hydrogen gas cap is formed in an upper portion of the scavenging reservoir beneath a cap rock seal. In some embodiments, the iron sulfide scale contains at least one of pyrite, pyrrhotite, troilite, greigite, mackinawite, or marcasite. In further embodiments, the iron sulfide scale is pyrite. In some embodiments, the H₂S is present in the sweet oil stream in an amount of less than about 4 ppm based on a total weight of the sweet oil stream, such as less than about 3 ppm, less than about 2 ppm, or less than about 1 ppm based on the total weight of the sweet oil stream. When the sour oil stream contains H₂S and CO₂, the one or more types of reactive iron-bearing minerals may also react with CO₂ to generate iron carbonate (FeCO₃) scale deposited within the scavenging reservoir. Therefore, carbon sequestration can also be achieved by the methods and systems of the present disclosure.

In some embodiments, the source reservoir and the scavenging reservoir are closely located to each other and are in direct fluid communication with each other via a reservoir connector well, or a crossflow well. In some embodiments, the source reservoir is positioned downhole and located beneath the scavenging reservoir. The source reservoir and the scavenging reservoir are separated by a low-permeability geological formation also known as a seal. In such cases, the source reservoir is likely to have a higher pore fluid pressure than the scavenging reservoir, thereby allowing the sour oil stream to flow from the source reservoir into the scavenging reservoir in the absence of a pump to lift the sour oil stream through the reservoir connector well, or a crossflow well. The co-location of the source reservoir and the scavenging reservoir minimizes transportation costs of the sour oil stream and reduces environmental impacts of emissions and fluid leakage in transit. In some embodiments, the source reservoir is in fluid communication with the scavenging reservoir via the reservoir crossflow well, and the scavenging reservoir is in fluid communication with a sour oil storage unit via the reservoir production well. In other embodiments, injection wells may perform roles such as introducing sour oil or gas from other locations, or injecting water to manage subsurface pressure in either of the source or scavenging reservoirs.

In some embodiments, the source reservoir and the scavenging reservoir are distantly located from each other and are not in direct fluid communication with each other. In such cases, the sour oil stream from the source reservoir may be pumped laterally in a pipework system and reinjected at an appropriate location into the scavenging reservoir. In some further embodiments, the sour oil stream from the source reservoir may be pumped into the sour oil storage unit or loaded into a transport container of a vehicle and delivered to the scavenging reservoir. In some embodiments, the vehicle includes, but is not limited to, a train, a truck, a van, a trailer, a semi-trailer, an articulated convoy, or a wagon. In some further embodiments, the scavenging reservoir can form a project hub to which the sour oil stream is transported from multiple surroundings or even distant sources.

The method of simultaneous oil sweetening and hydrogen production further includes flowing the sweet oil stream into a sweet oil storage unit via a sweet oil production well and flowing the hydrogen gas cap into a hydrogen storage unit via a hydrogen production well. In some embodiments, at least a partial or all of the hydrogen is dissolved in the sweetened hydrocarbons and should be separated using appropriate plant at surface. In some embodiments, the scavenging reservoir is in fluid communication with a water source via a water injection well. In some embodiments, the source reservoir is in fluid communication with a water source via a water injection well. In some embodiments, the scavenging reservoir and the source reservoirs share the same water injection well. In some embodiments, the water source includes one or more of deionized, tap, distilled, or fresh waters; natural, brackish, or brine waters; marine waters, natural hydrocarbon formation produced waters, or synthetic brines; filtered or untreated seawaters; mineral waters; treated or untreated wastewater; or other potable or non-potable waters containing one or more dissolved salts, minerals, or organic materials. In some embodiments, the aqueous water source contains at least about 80 wt. %, such as at least about 90 wt. %, at least about 95 wt. %, at least about 99 wt. %, at least about 99.9 wt. % or at least about 100 wt. % of water. In some embodiments, at least about 90 wt. %, at least about 95 wt. %, or at least about 99 wt. % of the water source by mass can be a brine solution. In some embodiments, the brine solution has a density of about 1.02 to about 1.2 g/mL, such as about 1.03 to about 1.15 g/mL, about 1.03 to about 1.1 g/mL, about 1.03 to about 1.05 g/mL, about 1.05 to about 1.2 g/mL, about 1.1 to about 1.2 g/ml, or about 1.15 to about 1.2 g/mL. In some embodiments, the density of the sour oil stream present in the source reservoir is about 10% to 50% less than the density of the brine solution, such as about 15% to about 40% less, about 20% to about 30% less, or about 25% less.

In some embodiments, the water source is positioned within the subsurface geological formations. In some embodiments, the water source originates from the same zone within the subsurface geological formation in which the source reservoir is located. Without intending to be bound by any particular theory, it is believed that if the water source originates within the same zone within the subsurface geological formation, it can reduce potential incompatibility issues such as scaling that could interfere with the injectivity of the sour oil stream. Further, it is believed that sourcing the water source from the subsurface geological formation can prevent reservoir overpressure and/or undesired fluid migration out of the injection zone. Additionally, it is believed that sourcing the water source from the subsurface geological formation can improve monitoring of gas sequestration and hydrogen production in the scavenging reservoir.

In some embodiments, the water source contains one or more biocides and/or one or more chemical inhibitors. The introduction and presence of these biocides and chemical inhibitors in the system can effectively inhibit the regeneration of H₂S in the scavenging reservoir by inhibiting the sulfate-reducing activity of sulfate-reducing bacteria (SRB) as well as reducing the consumption of the hydrogen produced within the scavenging reservoir. In some embodiments, the one or more biocides are selected from the group consisting of glutaraldehyde and quaternary ammonium compounds. In some embodiments, the one or more chemical inhibitors are selected from the group consisting of nitrate compounds, phosphate compounds, corrosion inhibitors, heavy metals, and acidic inhibitors.

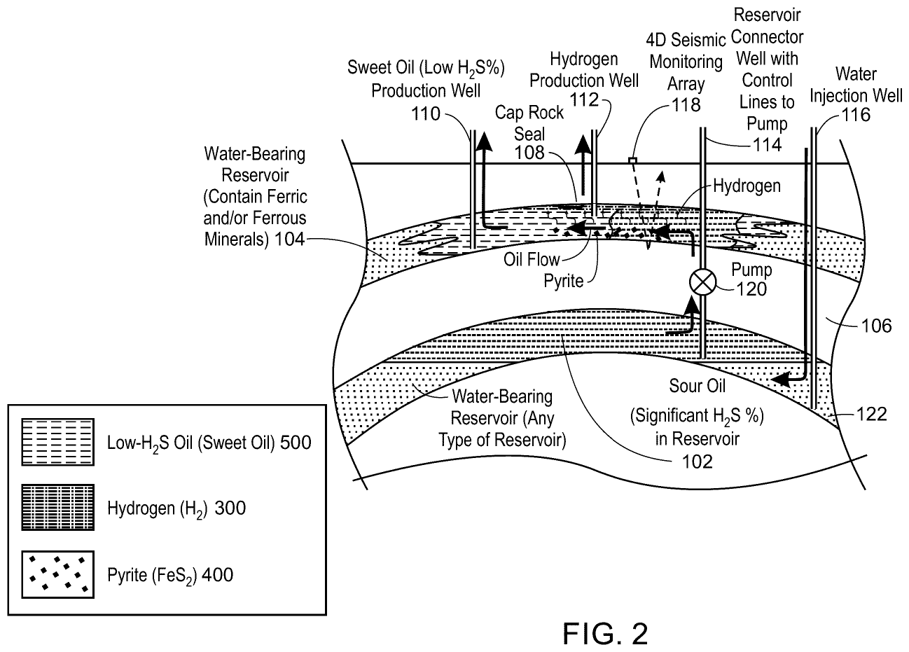

The hydrocarbons of the sour oil stream may generally include hydrocarbon liquids as well as hydrocarbon gases. In one non-limiting example, the hydrocarbons of the sour oil stream include crude oil and methane. In some embodiments, the water is generally denser than the sour oil stream. As a result, the hydrocarbons of the sour oil stream may accumulate as a positively buoyant fluid in an upper region of the source reservoir, as illustrated in FIG. 2. The relatively denser water present in a water zone of the source reservoir may then accumulate underneath the hydrocarbons, also as shown in FIG. 2. Furthermore, the hydrocarbons may also be differentiated by a positively buoyant layer of hydrocarbon gases over the hydrocarbon liquids of the sour oil stream.

The method of simultaneous oil sweetening and hydrogen production further includes monitoring a concentration of the iron sulfide scale in the scavenging reservoir, and in response to the concentration of the iron sulfide scale exceeding a threshold concentration, stopping the introduction of the sour oil stream from the source reservoir into the scavenging reservoir. In some embodiments, the concentration of the iron sulfide scale present in the scavenging reservoir is obtained by a surface-based remote sensing technique selected from the group consisting of a four-dimensional (4D) reflection seismic survey technique, a gravity survey technique, a magnetic survey technique, and a magnetotellurics survey technique. In further embodiments, the concentration of the iron sulfide scale is determined by a 4D seismic survey technique.

According to an aspect of the present disclosure, a system (100) for simultaneous oil sweetening and hydrogen production is provided. Although the figures and discussion imply a two-dimensional or cross-section of the subsurface reservoirs and/or geological formations, in practice the subsurface reservoirs and/or the geological formations will be three-dimensional.

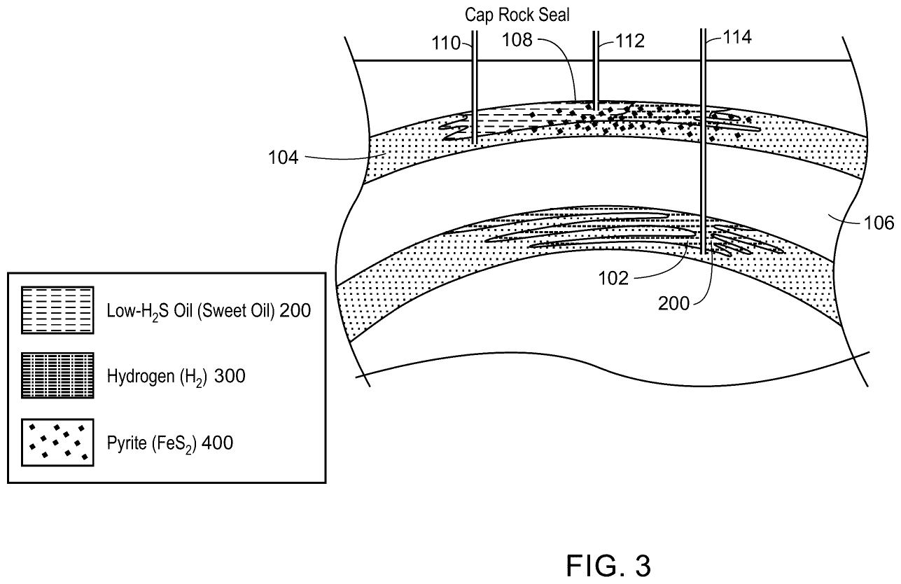

FIG. 1 illustrates an initial subsurface geological formation, where a source reservoir (102) and a scavenging reservoir (104) are co-located within the same geological structure. In this case, the hydrocarbon sweetening and amber hydrogen production process can be entirely subsurface as depicted in FIGS. 2 to 3. Also referring to FIG. 1, a sour oil and/or gas field is first identified by the methods described in the present disclosure. The sour hydrocarbon-bearing reservoir is defined as the source reservoir (102). The source reservoir (102) contains a sour oil stream (200) containing H₂S.

The source reservoir (102) is located downhole to a scavenging reservoir (104) that contains one or more types of reactive iron-bearing minerals. In some embodiments, the one or more types of reactive iron-bearing minerals includes, but are not limited to, ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, homblende, garnet (almandine), vivianite, jarosite, glauconite, iron chlorite, and native iron. The ferrous iron and/or ferric iron rich reservoir is defined as the scavenging reservoir (104). The scavenging reservoir (104) may be initially water-bearing, as is normally the case where subsurface reservoirs or aquifers are not hydrocarbon bearing. In some examples, the pore spaces and voids of the scavenging reservoir (104) may contain only air with no liquid present. The scavenging reservoir (104) may have a dissolved solids (TDS) content of less than about 300,000 ppm, such as less than about 200,000 ppm, less than about 100,000 ppm, less than about 50,000 ppm, less than about 10,000 ppm, less than about 5,000 ppm, or less than about 1,000 ppm. The scavenging reservoir (104) also contains negligible amounts of H₂ consuming minerals including, but not limited to, manganese (Mn) oxides, hydroxides, carbonates, sulphates (gypsum/anhydrite), alkaline silicate minerals, and labile organic matters. The scavenging reservoir (104) has a sulphate (SO₄²⁻) content of less than about 100 ppm, such as less than about 50 ppm, less than about 30 ppm, less than about 10 ppm, or less than about 1 ppm, as sulphate will react with and consume the hydrogen produced by the method of the present disclosure. In one embodiment, initial fluid pressure in the scavenging reservoir (104) is normal, hydrostatic pressure which makes the scavenging reservoir (104) a natural pressure sink for a higher-pressured fluid. In case of the scavenging reservoir (104) being at greater than normal pressure (overpressured), it may still be applicable to use it when the source reservoir (102) is overpressured by at least the same amount. Overpressure in the source reservoir (102) may occur naturally, or may be induced by a water injection well (116) as depicted in FIG. 2.

In some embodiments, the source reservoir (102) and the scavenging reservoir (104) each contain a naturally occurring base rock seal (106) that prevents downwards leakage of fluids from the source reservoir (102) and the scavenging reservoir (104), respectively. As a result, a sour oil stream (200) from the source reservoir (102) that has a higher pressure than fluids in the scavenging reservoir (104) will migrate from an upper portion of the source reservoir (102) to a bottom portion of the scavenging reservoir (104) via a crossflow well (not shown), but not be able to pass through the base rock seal (106), such that the sour oil stream (200) is treated in the scavenging reservoir (104) for simultaneous oil sweetening and hydrogen production. The base rock seal (106) may be impermeable rock or low-permeable rock, such as low-permeability geological strata. In some embodiments, the system (100) also includes a cap rock seal (108) overlying the scavenging reservoir (104). The cap rock seal (108) may be impermeable rock that prevents vertical migration of fluids within the scavenging reservoir (104) out of the system (100) in the upwards direction. In this way, the cap rock seal (108) and the base rock seal (106) may trap or otherwise prevent fluids in the source reservoir (102) and the scavenging reservoir (104) from migrating out of the system (100) to a lesser depth, a greater depth, or approximately same depth. In some embodiments, the cap rock seal (108) and base rock seal (106) may form a geological formation in the form of a reservoir that has low permeability, thereby preventing crossflow of fluids from the geological formation to the nearby porous geological formation structures. In some embodiments, the cap rock seal (108) and base rock seal (106) are widely distributed over the entire area of interest and not restricted to a portion of the project area as depicted in FIGS. 1-3. In some embodiments, both the cap rock seal (108) and base rock seal (106) are impermeable rock or low-permeable rock, such as low-permeability geological strata. The cap rock seal is defined as an impermeable rock layer or low-permeable rock layer that is positioned uphole to a reservoir, while the base rock seal is defined as an impermeable rock layer or low-permeable rock layer that is positioned downhole to the same reservoir. In further embodiments, the base rock seal (106) as depicted in FIGS. 1-3 is acting as a cap rock seal (108) for a second system (100-1) for simultaneous oil sweetening and hydrogen production. In some embodiments, the cap rock seal (108) as depicted in FIGS. 1-3 is acting as a base rock seal (106) for a third system (100-3) for simultaneous oil sweetening and hydrogen production.

Referring to FIG. 2, the system (100) further includes a reservoir connector well (114) configured to flow the sour oil stream (200) from the source reservoir (102) into the scavenging reservoir (104). In some embodiments, the source reservoir (102) is located downhole and beneath the scavenging reservoir (104) and is in fluid communication with the scavenging reservoir (104) through the reservoir connector well (114). In some embodiments, the reservoir connector well (114) may have a control line equipped with a pump (120) installed between the two reservoirs. The pump (120) is configured to lift the sour hydrocarbons (200) from the source reservoir (102) to the scavenging reservoir (104). In some embodiments, the pump (120) is an electric submersible pump.

In some embodiments, the scavenging reservoir (104) contains one or more types of reactive iron-bearing minerals configured to react the H₂S in the sour oil stream (200) with the one or more types of reactive iron-bearing minerals to generate a sweet oil stream (500) having a reduced H₂S content as compared to the sour oil stream (120), generate an iron sulfide scale (400) deposited within the scavenging reservoir (104), and form a hydrogen gas cap (300) in an upper portion of the scavenging reservoir (104) beneath the cap rock seal (108). When the sour oil stream (200) further contains CO₂, an iron carbonate scale is also generated within the scavenging reservoir due to the reaction of CO₂ with the one or more types of reactive iron-bearing minerals in the scavenging reservoir (104). In some embodiments, the system (100) also includes a sweet oil production well (110) configured to flow the sweet oil stream (500), a hydrogen production well (112) configured to flow the hydrogen gas cap (300), a water injection well (116) configured to flow water into the source reservoir (102), and a surface-based remote sensing sensor (118). In some embodiments, the surface-based remote sensing sensor (118) is configured to measure and monitor a concentration of the iron sulfide scale (400) in the scavenging reservoir (104). In some embodiments, the iron sulfide scale (400) is pyrite. Pyrite is deposited within the scavenging reservoir (104) as the H₂S is removed from the sour oil stream (200). Pyrite (400) may replace the one or more types of reactive iron-bearing minerals rather than occluding the porosity and permeability of the scavenging reservoir (104). The density of pyrite (400) is about 5 g/mL, which is greater than that of common reservoir-forming minerals such as quartz and carbonate, yet comparable to that of the one or more types of reactive iron-bearing minerals such as magnetite and hematite, which is about 5.2 g/mL. The density of pyrite is also greater than the density of iron hydroxides such as goethite, which is about 3.3 to about 4.3 g/mL. In cases of Fe hydroxides being the primary Fe-donors in the scavenging reservoir (104), their replacement with pyrite (400) may increase the bulk density and magnetic properties of the scavenging reservoir (104), enabling the application of surface-based remote sensing techniques to monitor the accumulation of pyrite (400) in the scavenging reservoir (104) through time. Such surface-based remote sensing techniques include, but are not limited to, a four-dimensional (4D) reflection seismic survey technique, a gravity survey technique, a magnetic survey technique, and a magnetotellurics survey technique. One or more of these techniques could be deployed on the land surface above the scavenging reservoir (104) to provide a full and repeatable subsurface image. Tracking and monitoring the accumulation of pyrite (400) through time will allow for decisions on the management of a large-scale filtration project such as location of ongoing injection and/or production wells.

Also referring to FIG. 2, the system (100) further includes a sweet oil storage unit (not shown) in fluid communication with the scavenging reservoir (104) via the sweet oil production well (100), a hydrogen storage unit (not shown) in fluid communication with the scavenging reservoir (104) via the hydrogen production well (112), a sour oil storage unit (not shown) in fluid communication with the source reservoir (104) via the reservoir connector well (114), and a water source (not shown) in fluid communication with the source reservoir (102) via the water injection well (116) extending downhole a depth within a water zone (122) of the source reservoir (102). A pressure support for the source reservoir (102) may be provided by the water injection well (116) in a water zone (122) below the sour oil stream (200). The sour oil stream (200) flows away from the source reservoir (102), driven by the higher pressure of those hydrocarbons present in the sour oil stream (200) relative to the pressure within the scavenging reservoir (104). Buoyancy of hydrocarbons relative to water or brine ensures that the sour hydrocarbons injected into the scavenging reservoir (104) flow upwards via the reservoir connector well (114), or the crossflow well (not shown). Migration of hydrocarbons in the scavenging reservoir (104) may be governed by a combination of the hydrocarbon buoyancy pressure and pressure gradient associated with the pressure in the hydrocarbons at the point of injection into the scavenging reservoir (104), relative to the initial (or far-field) scavenging reservoir pore fluid pressure. In further embodiments, migration of hydrocarbons in the scavenging reservoir (104) can be further controlled by the water injection well (116), which is drilled and completed in appropriate locations within the scavenging reservoir (104). The water injection well (116) allows hydrocarbons to flow not only from the source reservoir (102) to the scavenging reservoir (104), but also promotes lateral movement of hydrocarbons within the scavenging reservoir (104) from the point of injection (e.g., the crossflow well) to the point of production (e.g., the sweet oil production well (100)).

These pressure drives ensure that the locations of the sweet oil production wells (110) used to extract the sweet oil stream (500) containing the sweetened hydrocarbons can be selected laterally away from the injection points. As the hydrocarbons flow within the scavenging reservoir (104) from injection to production wells, exposure of H₂S to the ferrous and/or ferric minerals in the scavenging reservoir (104) allows the H₂S-fixing reaction to occur as depicted in Equations 1 and 2, as the sour oil stream (200) flows through the pore network.

Referring to FIG. 3, the system (100) after simultaneous oil sweetening and hydrogen production shows a depleted sour hydrocarbon field of the source reservoir (102) and an accumulated pyrite (400) present in the scavenging reservoir (104). The accumulated pyrite (400) may replace the original one or more types of reactive iron-bearing minerals as depicted in FIG. 1. Residual hydrocarbons presented in the sour oil stream (200) may be found in both the source reservoir (102) and the scavenging reservoir (104). The system (100) after simultaneous oil sweetening and hydrogen production may be fully plugged downhole to ensure the reservoirs are permanently isolated from one another, returning the fluid dynamics of the sedimentary basin to the initial stage as depicted in FIG. 1.

Although only one source reservoir and one scavenging reservoir are discussed in this illustrative example, it will be understood by those of ordinary skill in the art that the system for simultaneous oil sweetening and hydrogen production may include any number of source reservoirs and scavenging reservoirs that can be combined to produce sweetened oil and hydrogen. In some embodiments, the system includes two or more source reservoirs, such as two, three, four, five, six, seven, or eight source reservoirs. In some embodiments, the system includes two or more scavenging reservoirs, such as two, three, four, five, six, seven, or eight scavenging reservoirs. In some embodiments, each of the two or more source reservoirs is in fluid communication with each of the two or more scavenging reservoirs, respectively. In some embodiments, each of the two or more source reservoirs is in fluid communication with one scavenging reservoir. In some embodiments, each of the two or more scavenging reservoirs is in fluid communication with one source reservoir.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Embodiment 1: A method of simultaneous oil sweetening and hydrogen production, the method comprising:
introducing a sour oil stream comprising hydrogen sulfide (H₂S) from a source reservoir into a scavenging reservoir comprising one or more types of reactive iron-bearing minerals;
contacting the sour oil stream with the one or more types of reactive iron-bearing minerals present in the scavenging reservoir, thereby generating a sweet oil stream having a reduced H₂S content as compared to the sour oil stream and an iron sulfide scale deposited within the scavenging reservoir and forming a hydrogen gas cap in an upper portion of the scavenging reservoir beneath a cap rock seal; and
flowing the sweet oil stream into a sweet oil storage unit via a sweet oil production well and flowing the hydrogen gas cap into a hydrogen storage unit via a hydrogen production well.

Embodiment 2: The method of embodiment 1, wherein the one or more types of reactive iron-bearing minerals are selected from the group consisting of ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, homblende, garnet (almandine), vivianite, jarosite, glauconite, iron chlorite, and native iron.

Embodiment 3: The method of embodiment 1 or 2, wherein the one or more types of reactive iron-bearing minerals comprise ferrous iron and ferric iron.

Embodiment 4: The method of any one of embodiments 1-3, wherein the iron sulfide scale comprises at least one of pyrite, pyrrhotite, troilite, greigite, mackinawite, or marcasite.

Embodiment 5: The method of any one of embodiments 1-4, wherein the iron sulfide scale comprises pyrite.

Embodiment 6: The method of any one of embodiments 1-5, wherein the H₂S is present in the sour oil stream in an amount of more than about 1000 parts per million (ppm) based on a total weight of the sour oil stream.

Embodiment 7: The method of any one of embodiments 1-6, the H₂S is present in the sweet oil stream in an amount of less than about 4 ppm based on a total weight of the sweet oil stream.

Embodiment 8: The method of any one of embodiments 1-7, wherein the source reservoir and the scavenging reservoir are distantly located from each other and are not in direct fluid communication with each other.

Embodiment 9: The method of any one of embodiments 1-8, wherein the source reservoir and the scavenging reservoir are closely located to each other and are in direct fluid communication with each other via a reservoir connector well.

Embodiment 10: The method of any one of embodiments 1-9, wherein the source reservoir is located beneath the scavenging reservoir and is separated by a low-permeability geological formation.

Embodiment 11: The method of any one of embodiments 1-10, wherein the source reservoir has a higher pore fluid pressure than the scavenging reservoir, thereby allowing the sour oil stream to flow from the source reservoir into the scavenging reservoir in the absence of a pump to lift the sour oil stream.

Embodiment 12: The method of any one of embodiments 1-11, wherein the source reservoir is in fluid communication with the scavenging reservoir via the reservoir connector well, and the scavenging reservoir is in fluid communication with a sour oil storage unit via the reservoir connector well.

Embodiment 13: The method of any one of embodiments 1-12, wherein the source reservoir is in fluid communication with a water source via a water injection well.

Embodiment 14: The method of any one of embodiments 1-13, wherein the scavenging reservoir is in fluid communication with the water source via the water injection well.

Embodiment 15: The method of any one of embodiments 1-14, further comprising:
monitoring a concentration of the iron sulfide scale in the scavenging reservoir; and
in response to the concentration of the iron sulfide scale exceeding a threshold concentration, stopping the introduction of the sour oil stream from the source reservoir into the scavenging reservoir.

Embodiment 16: The method of any one of embodiments 1-15, wherein the concentration of the iron sulfide scale present in the scavenging reservoir is obtained by a surface-based remote sensing technique selected from the group consisting of a four-dimensional (4D) reflection seismic survey technique, a gravity survey technique, a magnetic survey technique, and a magnetotellurics survey technique.

Embodiment 17: A system for simultaneous oil sweetening and hydrogen production, the system comprising:
a source reservoir comprising a sour oil stream comprising hydrogen sulfide (H₂S);
a reservoir connector well configured to flow the sour oil stream from the source reservoir into a scavenging reservoir;
the scavenging reservoir comprising one or more types of reactive iron-bearing minerals configured to react the H₂S in the sour oil stream with the one or more types of reactive iron-bearing minerals to generate a sweet oil stream having a reduced H₂S content as compared to the sour oil stream, an iron sulfide scale deposited within the scavenging reservoir, and a hydrogen gas cap in an upper portion of the scavenging reservoir beneath a cap rock seal;
a sweet oil production well configured to flow the sweet oil stream;
a hydrogen production well configured to flow the hydrogen gas cap;
a water injection well configured to flow water into the source reservoir, thereby allowing the sour oil stream to flow from the source reservoir to the scavenging reservoir and supporting fluid movement within the scavenging reservoir and the source reservoir; and
a surface-based remote sensing sensor.

Embodiment 18: The system of embodiment 17, wherein the source reservoir is located beneath the scavenging reservoir and is in fluid communication with the scavenging reservoir via the reservoir connector well.

Embodiment 19: The system of embodiment 17 or 18, wherein the surface-based remote sensing sensor is configured to measure and monitor a concentration of the iron sulfide scale in the scavenging reservoir.

Embodiment 20: The system of any one of embodiments 17-19, wherein the system further comprises:
a sweet oil storage unit in fluid communication with the scavenging reservoir via the sweet oil production well;
a hydrogen storage unit in fluid communication with the scavenging reservoir via the hydrogen production well;
a sour oil storage unit in fluid communication with the source reservoir via the reservoir connector well; and
a water source in fluid communication with the source reservoir via the water injection well.

1. A method of simultaneous oil sweetening and hydrogen production, the method comprising:
introducing a sour oil stream comprising hydrogen sulfide (H₂S) from a source reservoir into a scavenging reservoir comprising one or more types of reactive iron-bearing minerals;
contacting the sour oil stream with the one or more types of reactive iron-bearing minerals present in the scavenging reservoir, thereby generating a sweet oil stream having a reduced H₂S content as compared to the sour oil stream and an iron sulfide scale deposited within the scavenging reservoir and forming a hydrogen gas cap in an upper portion of the scavenging reservoir beneath a cap rock seal; and
flowing the sweet oil stream into a sweet oil storage unit via a sweet oil production well and flowing the hydrogen gas cap into a hydrogen storage unit via a hydrogen production well.

2. The method of claim 1, wherein the one or more types of reactive iron-bearing minerals are selected from the group consisting of ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, hornblende, garnet (almandine), vivianite, jarosite, glauconite, iron chlorite, and native iron.

3. The method of claim 1, wherein the one or more types of reactive iron-bearing minerals comprise ferrous iron and ferric iron.

4. The method of claim 1, wherein the iron sulfide scale comprises at least one of pyrite, pyrrhotite, troilite, greigite, mackinawite, or marcasite.

5. The method of claim 4, wherein the iron sulfide scale comprises pyrite.

6. The method of claim 1, wherein the H₂S is present in the sour oil stream in an amount of more than about 1000 parts per million (ppm) based on a total weight of the sour oil stream.

7. The method of claim 1, wherein the H₂S is present in the sweet oil stream in an amount of less than about 4 ppm based on a total weight of the sweet oil stream.

8. The method of claim 1, wherein the source reservoir and the scavenging reservoir are distantly located from each other and are not in direct fluid communication with each other.

9. The method of claim 1, wherein the source reservoir and the scavenging reservoir are closely located to each other and are in direct fluid communication with each other via a reservoir connector well.

10. The method of claim 9, wherein the source reservoir is located beneath the scavenging reservoir and is separated by a low-permeability geological formation.

11. The method of claim 9, wherein the source reservoir has a higher pore fluid pressure than the scavenging reservoir, thereby allowing the sour oil stream to flow from the source reservoir into the scavenging reservoir in the absence of a pump to lift the sour oil stream.

12. The method of claim 1, wherein the source reservoir is in fluid communication with the scavenging reservoir via the reservoir connector well, and the scavenging reservoir is in fluid communication with a sour oil storage unit via the reservoir connector well.

13. The method of claim 1, wherein the source reservoir is in fluid communication with a water source via a water injection well.

14. The method of claim 13, wherein the scavenging reservoir is in fluid communication with the water source via the water injection well.

15. The method of claim 1, further comprising:
monitoring a concentration of the iron sulfide scale in the scavenging reservoir; and
in response to the concentration of the iron sulfide scale exceeding a threshold concentration, stopping the introduction of the sour oil stream from the source reservoir into the scavenging reservoir.

16. The method of claim 15, wherein the concentration of the iron sulfide scale present in the scavenging reservoir is obtained by a surface-based remote sensing technique selected from the group consisting of a four-dimensional (4D) reflection seismic survey technique, a gravity survey technique, a magnetic survey technique, and a magnetotellurics survey technique.

17. A system for simultaneous oil sweetening and hydrogen production, the system comprising:
a source reservoir comprising a sour oil stream comprising hydrogen sulfide (H₂S);
a reservoir connector well configured to flow the sour oil stream from the source reservoir into a scavenging reservoir;
the scavenging reservoir comprising one or more types of reactive iron-bearing minerals configured to react the H₂S in the sour oil stream with the one or more types of reactive iron-bearing minerals to generate a sweet oil stream having a reduced H₂S content as compared to the sour oil stream, an iron sulfide scale deposited within the scavenging reservoir, and a hydrogen gas cap in an upper portion of the scavenging reservoir beneath a cap rock seal;
a sweet oil production well configured to flow the sweet oil stream;
a hydrogen production well configured to flow the hydrogen gas cap;
a water injection well configured to flow water into the source reservoir, thereby allowing the sour oil stream to flow from the source reservoir to the scavenging reservoir and supporting fluid movement within the scavenging reservoir and the source reservoir; and
a surface-based remote sensing sensor.

18. The system of claim 17, wherein the source reservoir is located beneath the scavenging reservoir and is in fluid communication with the scavenging reservoir via the reservoir connector well.

19. The system of claim 17, wherein the surface-based remote sensing sensor is configured to measure and monitor a concentration of the iron sulfide scale in the scavenging reservoir.

20. The system of claim 17, wherein the system further comprises:
a sweet oil storage unit in fluid communication with the scavenging reservoir via the sweet oil production well;
a hydrogen storage unit in fluid communication with the scavenging reservoir via the hydrogen production well;
a sour oil storage unit in fluid communication with the source reservoir via the reservoir connector well; and
a water source in fluid communication with the source reservoir via the water injection well.
